(19) United States
(12) Patent Application Publication
(10) Pub. No.: US 2009/0235991 A1
(43) Pub. Date: Sep. 24, 2009

(54) DETERGENT RELEASING DEVICE FOR WATER TANK

(76) Inventor: Jen Fou Nieh, Shengang Township (TW)

Correspondence Address: SINORICA, LLC, 2275 Research Blvd., Suite 500, ROCKVILLE, MD, 20850, US

(21) Appl. No.: 12/050,577

(22) Filed: Mar. 18, 2008

(51) Int. Cl. F16K 31/18; B67D 5/06

(52) U.S. Cl. 137/409; 222/559

(57) ABSTRACT

A detergent releasing device for toilet water tank includes a case connected to inside of the water tank and a releasing unit is connected with the case. The releasing unit includes a guide member with a hollow central tube in which an operation rod is movably inserted. The central tube includes two slots located close to two ends thereof. The operation rod includes an annular space in which a fixed amount of detergent is stored via one of the slots. The operation rod is connected with a float member which moves the operation rod up and down within the central tube. The fixed amount of detergent released when flushing.

### FIELD OF THE INVENTION

The present invention relates to a releasing device for releasing a fixed amount of detergent into the water tank when flushing.

### BACKGROUND OF THE INVENTION

A conventional detergent used for toilet water tank generally is a solid block which can be melted in the water so that the detergent flushes the toilet when flushing. However, the solid detergent block is dropped into the water tank and stays at a position where can be close to the outlet or the inlet. If the solid detergent block is located close to the outlet, it might moves to stock the outlet. If the solid detergent block is located close to the inlet, it melts quickly because the stream of the inlet water so that it is used out within 3-5 days. Furthermore, the density of the mixture of the detergent and water cannot be controlled and this may require more solid detergent blocks.

The present invention intends to provide a detergent releasing device which releases a fixed amount of detergent during each flushing action.

### SUMMARY OF THE INVENTION

The present invention relates to a detergent releasing device which comprises a case having a space defined therein and an open end is defined in a bottom of the case. The case is connected to an inside of a toilet water tank. A releasing unit is engaged with the open end and includes a guide member which includes a hollow central tube. A first slot and a second slot are defined through a wall of the central tube and located close to two ends of the central tube. An operation rod is movably inserted in the central tube and includes a first flange extending radially from a top end thereof. A neck is located at a mediate portion of the operation rod so as to define an annular space between the neck and an inner periphery of the central tube. Two sealing rings are mounted to the operation rod and the neck is located between the two sealing rings which are in contact with the inner periphery of the central tube. A connection end is connected to a lower end of the operation rod. A float member is a hollow cylindrical member and includes an inner tube located at a center thereof. A board is radially connected to an inner periphery of the inner tube and a receiving member is located on the board. The connection end of the operation rod is fixed to the receiving member and a plurality of holes defined through the board. The annular space stores a fixed amount of detergent which releases to the inner tube and mixes with the water in the water tank via the second slot when flushing.

The primary object of the present invention is to provide a detergent releasing device which releases a fixed amount of detergent during each flushing action. Another object of the present invention is to provide a detergent releasing device which releases a fixed amount of detergent during each flushing action when the controlled water level pushes the float member upward.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the detergent releasing device of the present invention;

FIG. 2 is an exploded view to show the detergent releasing device of the present invention;

FIG. 2A is an enlarged view of the circled portion in FIG. 2;

FIG. 3 is a cross sectional view to show that the detergent releasing device is not yet been used, the locking ring secures the float member;

FIG. 4 is a cross sectional view to show that the detergent releasing device is ready to be used, the locking ring is removed;

FIG. 4A is an enlarged cross sectional view of the circled portion in FIG. 4;

FIG. 5 shows that the detergent releases when flushing, and FIG. 5A is an enlarged cross sectional view of the circled portion in FIG. 5.

### DETAILED DESCRIPTION OF THE PREFERRED EMBODIMENT

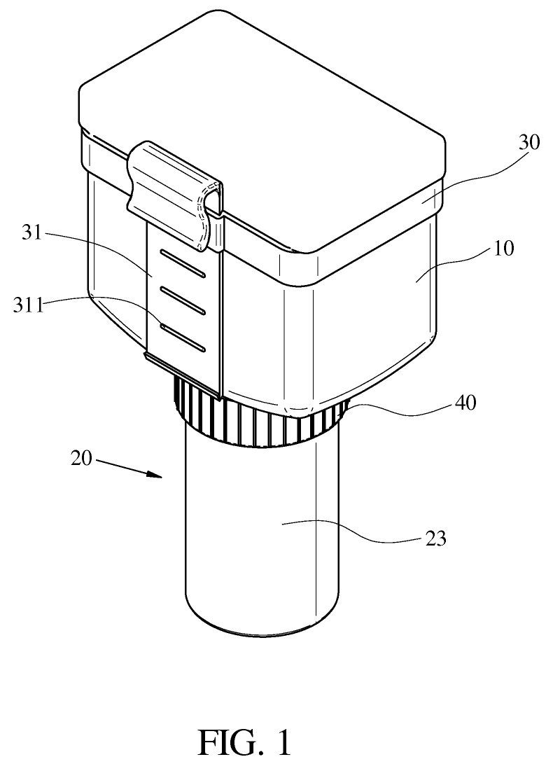

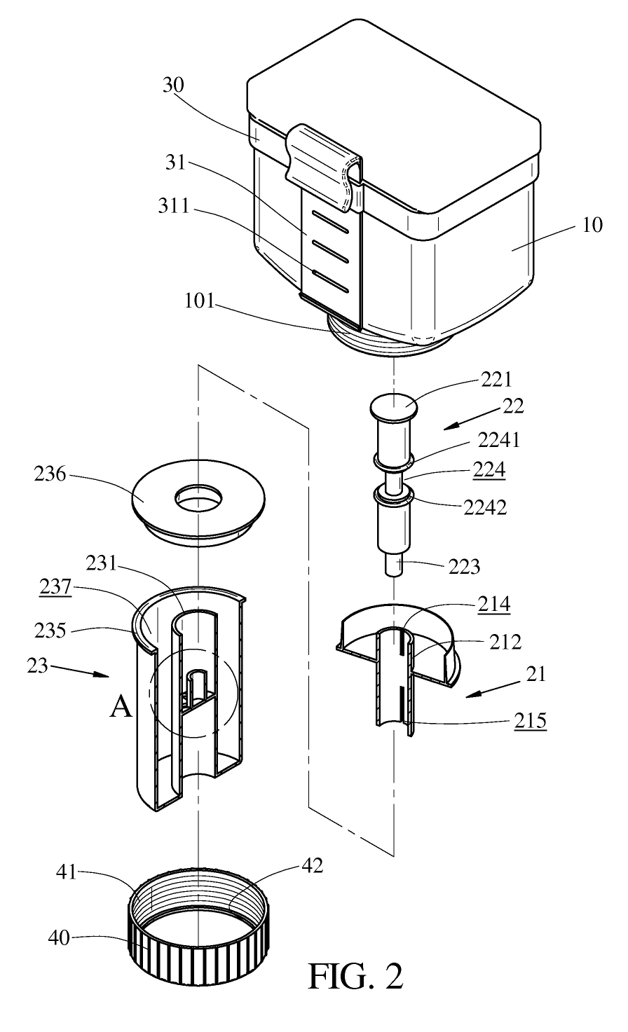

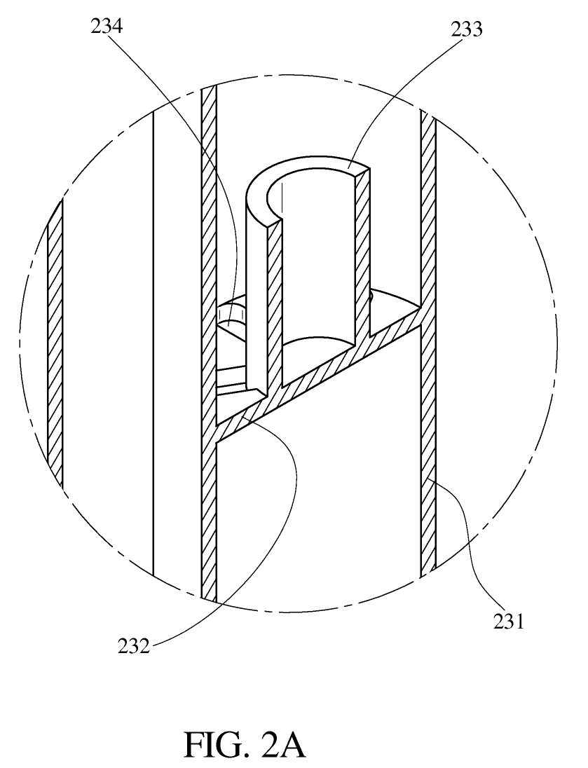

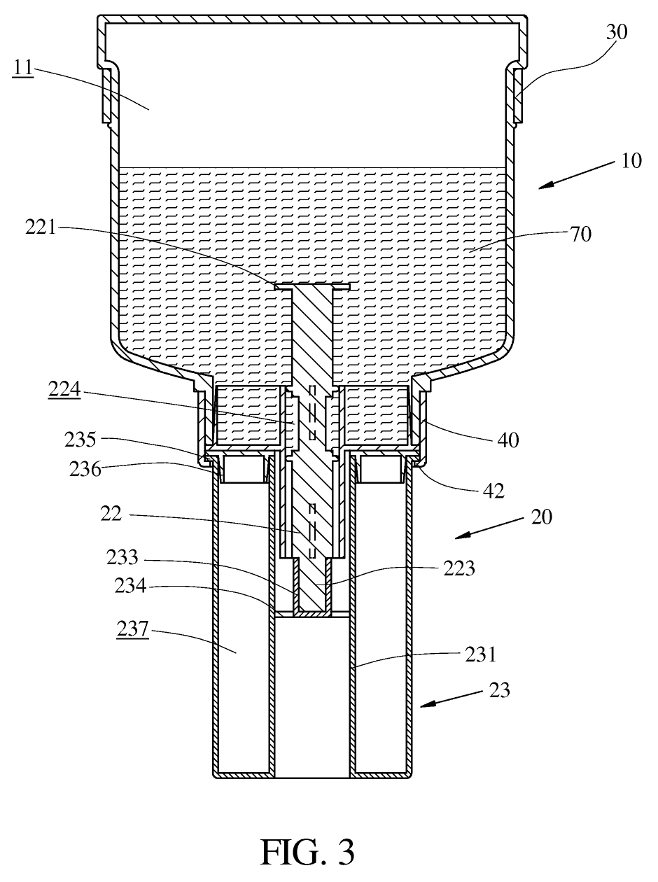

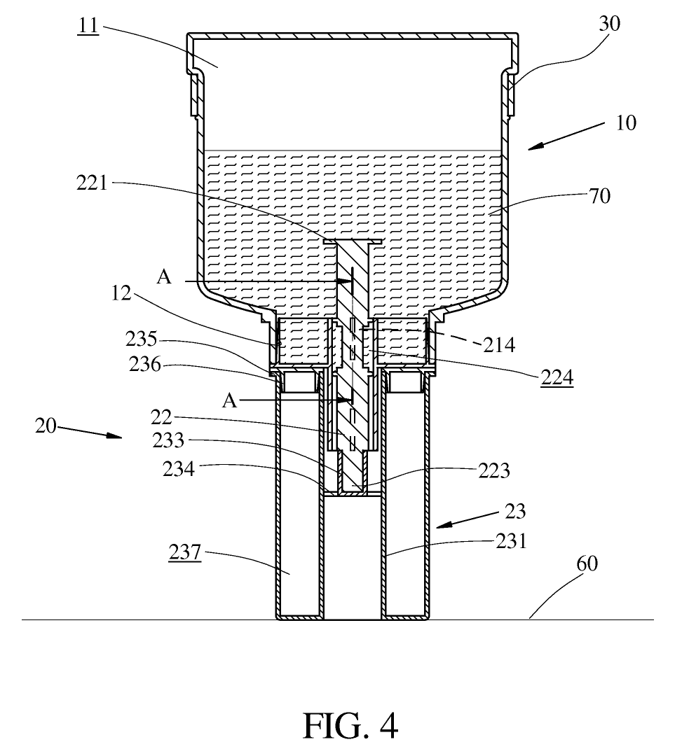

Referring to FIGS. 1, 2, 2A and 3, the detergent releasing device for toilet water tank of the present invention comprises a case 10 having a space 11 defined therein and an open end 12 is defined in a bottom of the case 10. A threaded neck 101 extends from the bottom of the case 10 and encloses the open end 12. A collar 30 is mounted to outside of the case 10 and a hook 31 is connected to the collar 30. The hook 31 is hooked to an inside or a wall of the water tank (not shown). The hook 31 includes an elongate plate which is movably located between the collar 30 and the case 10, a plurality of ridges 311 extend from an outside of the plate and one of the ridges 311 is stopped by the collar 30. By arranging the ridges 311 to be stopped with the collar 30, the height of the case 10 in the water tank can be adjusted.

A releasing unit 20 is engaged with the open end 12 and partially received in the space 11 of the case 10. The releasing unit 20 includes a guide member 21 which includes a hollow central tube 212 and a first slot 214 and a second slot 215 are defined through a wall of the central tube 212. The first slot 214 and the second slot 215 are located close to two ends of the central tube 212.

An operation rod 22 is movably inserted in the central tube 212 and includes a first flange 221 extending radially from a top end thereof so as to be stopped by the top end of the central tube 212. A neck is located at a mediate portion of the operation rod 22 so as to define an annular space 224 between the neck and an inner periphery of the central tube 212. Two sealing rings 2241, 2242 are mounted to the operation rod 22 and the neck located between the two sealing rings 2241, 2242 which are in contact with the inner periphery of the central tube 212 so ensure that the annular space 224 is sealed when not yet flushing. A connection end 223 is connected to a lower end of the operation rod 22.

A float member 23 is a hollow cylindrical member and includes an inner tube 231 located at a center thereof, and the float member 23 has a closed lower end except for the open end of the inner tube 231. A second flange 235 extends radially outward from a top end of the float member 23. A cover 236 is mounted to a top end of the float member 23 and includes a central hole which communicates with the inner tube 231, such that an enclosed space is defined between the cover 236, the inner periphery of the float member 23 and the closed lower end. The enclosed space makes the float member 23 to be moved by water. A board 232 is radially connected to an inner periphery of the inner tube 231 and a receiving member 233 is located on the board 232. The connection end 223 of the operation rod 22 is fixed to the receiving member 23. A plurality of holes 234 are defined through the board 232.

When not in use, a locking ring 40 is used and includes inner threads 41 which are threadedly connected to the threaded neck 101. An annular lip 42 extends radially inward from the locking ring 40 and the second flange 235 is removably rested on the annular lip 42.

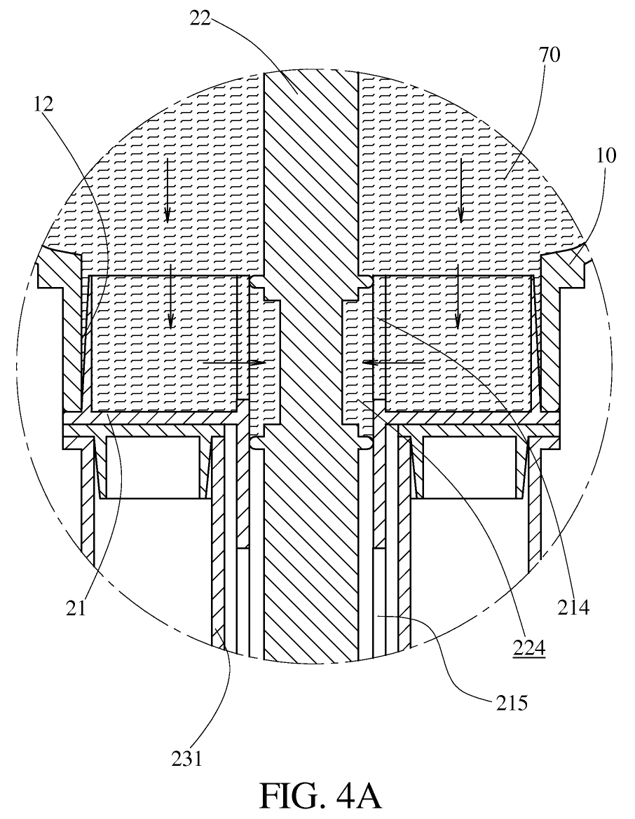

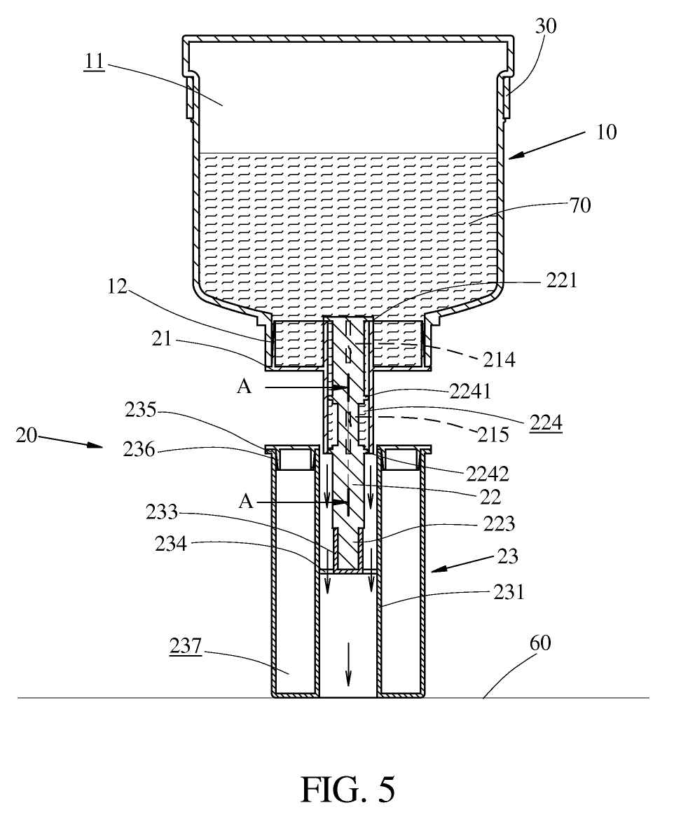

As shown in FIGS. 4 and 4A, when in use, the locking ring 40 is removed and the water 60 pushes the float member 23 upward, so that the detergent enters the annular space 224 via the first slot 214. The detergent does not leak because of the two sealing rings 2241, 2242.

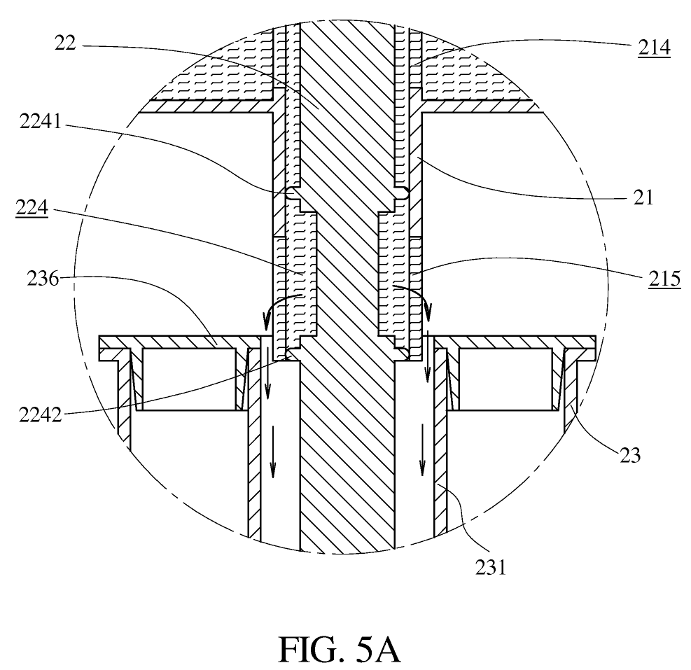

As shown in FIGS. 5 and 5A, when flushing, the water level is lowered and the float member 23 together with the operation rod 22 are lowered due to gravity until the first flange 221 is stopped by the top end of the central tube 212. The fixed amount of detergent in the annular space 224 is released from the second slot 215 and drops into the water tank via the holes 234 in the board 232.

The detergent releasing device ensures that a fixed amount of detergent is released in each flushing. By adjusting the height of the case 10 in the water tank can control when the detergent is released, such as when ⅔ of the water in the water tank flushes away, the detergent is mixed with the left ⅓ water to flush into the bowl of the toilet.

While we have shown and described the embodiment in accordance with the present invention, it should be clear to those skilled in the art that further embodiments may be made without departing from the scope of the present invention.

What is claimed is:

1. A detergent releasing device comprising:
a case having a space defined therein and an open end defined in a bottom of the case;
a releasing unit engaged with the open end and partially received in the space of the case, the releasing unit including a guide member which includes a hollow central tube and a first slot and a second slot defined through a wall of the central tube and located close to two ends of the central tube;
an operation rod movably inserted in the central tube and including a first flange extending radially from a top end thereof, a neck is located at a mediate portion of the operation rod so as to define an annular space between the neck and an inner periphery of the central tube, two sealing rings mounted to the operation rod and the neck located between the two sealing rings which are in contact with the inner periphery of the central tube, a connection end connected to a lower end of the operation rod, and
a float member being a hollow cylindrical member and including an inner tube located at a center thereof, a board radially connected to an inner periphery of the inner tube and a receiving member located on the board, the connection end of the operation rod fixed to the receiving member, a plurality of holes defined through the board.

2. The device as claimed in claim 1, wherein a collar is mounted to outside of the case and a hook is connected to the collar, the hook is adapted to be hooked to an inside of the water tank.

3. The device as claimed in claim 2, wherein the hook includes an elongate plate which is movably located between the collar and the case, a plurality of ridges extend from an outside of the plate and one of the ridges is stopped by the collar.

4. The device as claimed in claim 1, wherein a threaded neck extends from the bottom of the case and encloses the open end, the float member includes a second flange extending radially outward from a top end thereof, a locking ring includes inner threads which are threadedly connected to the threaded neck, an annular lip extends radially inward from the locking ring and the second flange is removably rested on the annular lip.

5. The device as claimed in claim 1,wherein a cover is mounted to a top end of the float member and includes a central hole which communicates with the inner tube.
